(19) United States
(12) Patent Application Publication
(10) Pub. No.: US 2004/0174253 A1
(43) Pub. Date: Sep. 9, 2004

(54) Automatic warning system for cars

(75) Inventor: Chien-Yuan Chen, Banchiau City (TW)

Correspondence Address: TROXELL LAW OFFICE PLLC, SUITE 1404, 5205 LEESBURG PIKE, FALLS CHURCH, VA, 22041, US

(73) Assignee: Power Digital Communication Co., Ltd.

(21) Appl. No.: 10/378,593

(22) Filed: Mar. 5, 2003

(51) Int. Cl. B60Q 1/00

(52) U.S. Cl. 340/425.5

(57) ABSTRACT

An automatic warning system for cars, including at least a transmitting unit installed in the car, which can send digital data via wireless transmission and which upon activation connects to a receiving unit; a picture transferal unit, which includes at least one camera structure, which can send pictures taken inside and outside of the car to the transmitting unit; a measuring unit, which registers collisions and abnormal entering into the car and automatically activates the transmitting unit and picture transferal unit; which will in case of abnormal entering into the car as by a car thief or in case of a car accident automatically take pictures of the inner and outer situation of the car and transfer them to the predefined receiving unit, which can be placed at the next police station or with the car owner, thus enabling them to take immediate appropriate measures.

### BACKGROUND OF THE INVENTION

1) Field of the Invention

The present invention relates to an automatic warning system for cars, specifically in case of abnormal entering into the car as by a car thief or in case of a car accident automatically activate the transmitting unit and the picture transferal unit, to take immediate pictures of the situation and transfer them to the next police station or to the car owner, thus enabling them to take immediate appropriate measures.

2) Description of the Prior Art

Normal cars will often be confronted with sudden, unexpected situations while traveling the streets. In these situations, the driver is often required to help third persons. On normal streets with frequent passing of cars and with mindful drivers, other drivers or passengers of their cars will soon come to help or call for help, if necessary. The persons involved can be helped quickly.

But not all accidents take place on streets with frequent passing of cars. Not always are there other drivers able to come to help. Often it is the case, that the driver himself after the accident is not longer able to help himself or to call for help by himself. In this case, the driver can do nothing to help himself in this situation. Furthermore not all dangers for the car take place while traveling on the road. While parking the car, there is always the danger of an abnormal entering into the car, as through a car theft. In these cases the driver or car owner has no possibility to prevent the act of crime.

### SUMMARY OF THE INVENTION

The present invention of an automatic warning system for cars comprises a transmitting unit, a picture transferal unit and a measuring unit, with the transmitting unit installed in the car able to send digital data via wireless transmission and able to connect to a receiving unit upon activation; the picture transferal unit comprising at least one camera structure, which is connected to the transmitting unit and can send pictures taken inside and outside of the car to this transmitting unit; and the measuring unit, which is connected to the transmitting unit and the picture transferal unit, registering collisions and abnormal entering into the car and automatically activating the transmitting unit and picture transferal unit, which will report this abnormal situation at the next police station or the predefined receiving unit, thus enabling them to take immediate appropriate measures.

### BRIEF DESCRIPTION OF THE DRAWINGS

FIG. 1 is an overview drawing of the complete system described in the present invention.

FIG. 2 is a drawing of the present invention in the situation of a collision.

FIG. 3 is a schematic flowchart display of the course of events of the present invention in the situation of a collision.

FIG. 4 is a drawing of the present invention in the situation of a car theft.

FIG. 5 is a schematic flowchart display of the course of events of the present invention in the situation of a car theft.

### DETAILED DESCRIPTION OF THE PREFERRED EMBODIMENT

The present invention is now described in further detail through use of the attached pictures and an example of an ideal-structure.

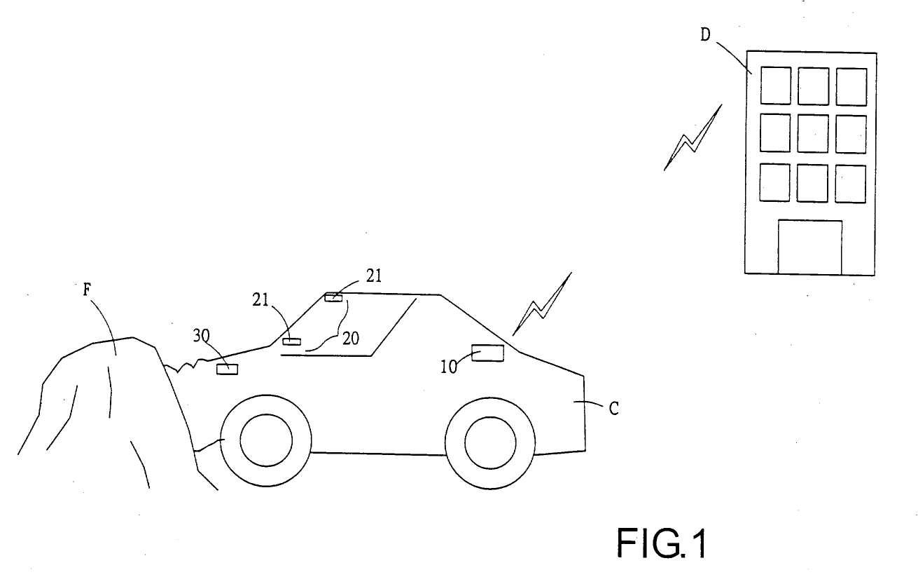

On FIG. 1 the structure of the complete warning system used in the present invention of an automatic warning system for cars is displayed, comprising:

A transmitting unit (10), which is mounted into a fixed place in the car (C), can send digital data via wireless transmission and which upon activation connects to a receiving unit, which can be placed at the next police station or with the car owner.

A picture transferal unit (20), which comprises at least one camera structure (21), with the camera structure (21) connected to the transmitting unit (10) and able to send pictures taken inside and outside of the car (C) to the transmitting unit (10).

A measuring unit (30), which is connected to the transmitting unit (10) and the picture transferal unit (20) and which registers collisions and abnormal entering into the car (C) and automatically activates the transmitting unit (10) and picture transferal unit (20).

Furthermore the complete warning system can be connected to a global positioning system (GPS), which determines the position of the car via satellite, as long as the warning system is activated.

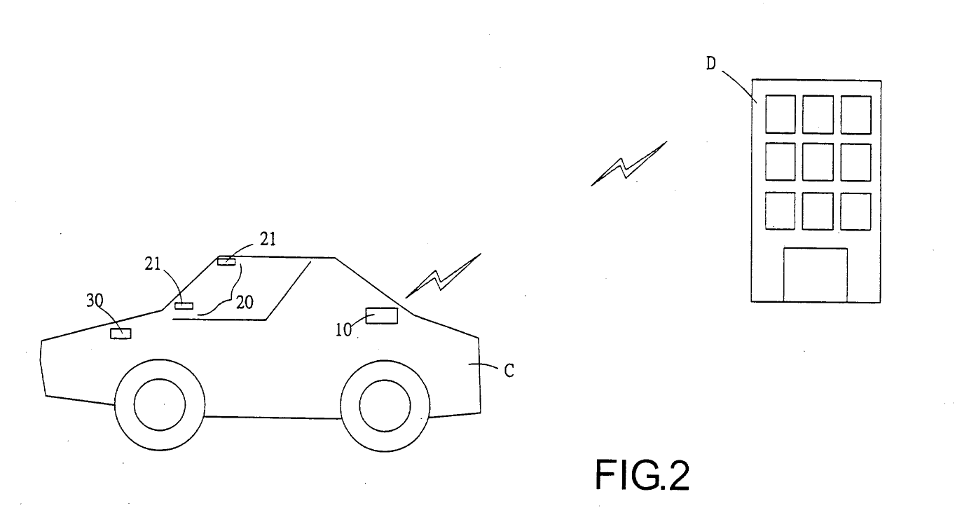

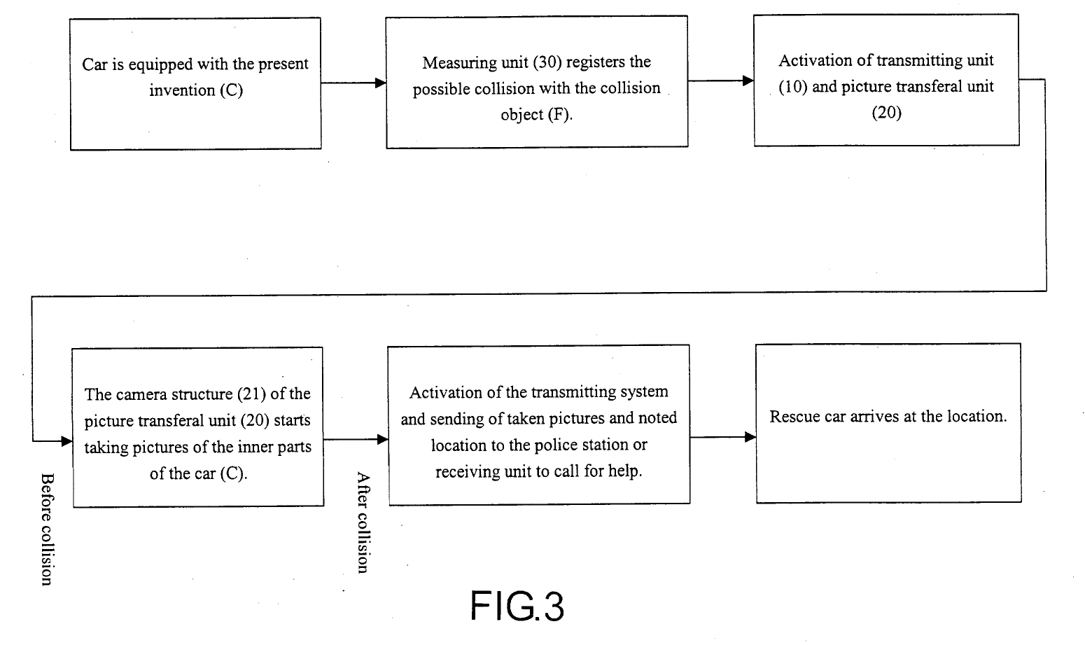

On FIG. 2 and FIG. 3 we can see that in case of the collision of the car (C) with a collision object (F) the measuring unit (30) of the warning system will register the collision of the car (C) and activate the transmitting unit (10) and the picture transferal unit (20). The camera structures (21) of the picture transferal unit (20) take immediate pictures of the inner and outer situation of the car (C). In case of a car accident, the transmitting unit (10) transfers immediate pictures of the location of the car (C) to the next police station or to a receiving unit (D) of the car owner, thus enabling them to take immediate appropriate measures.

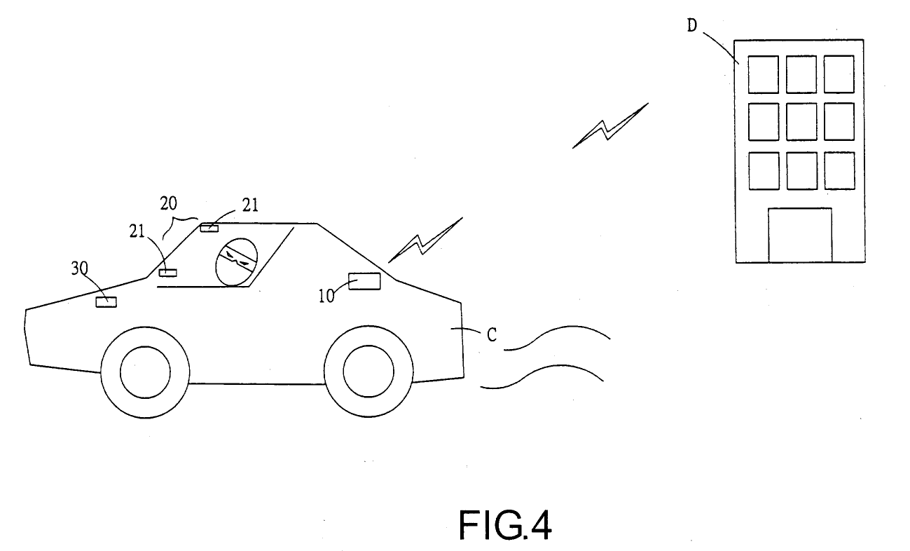

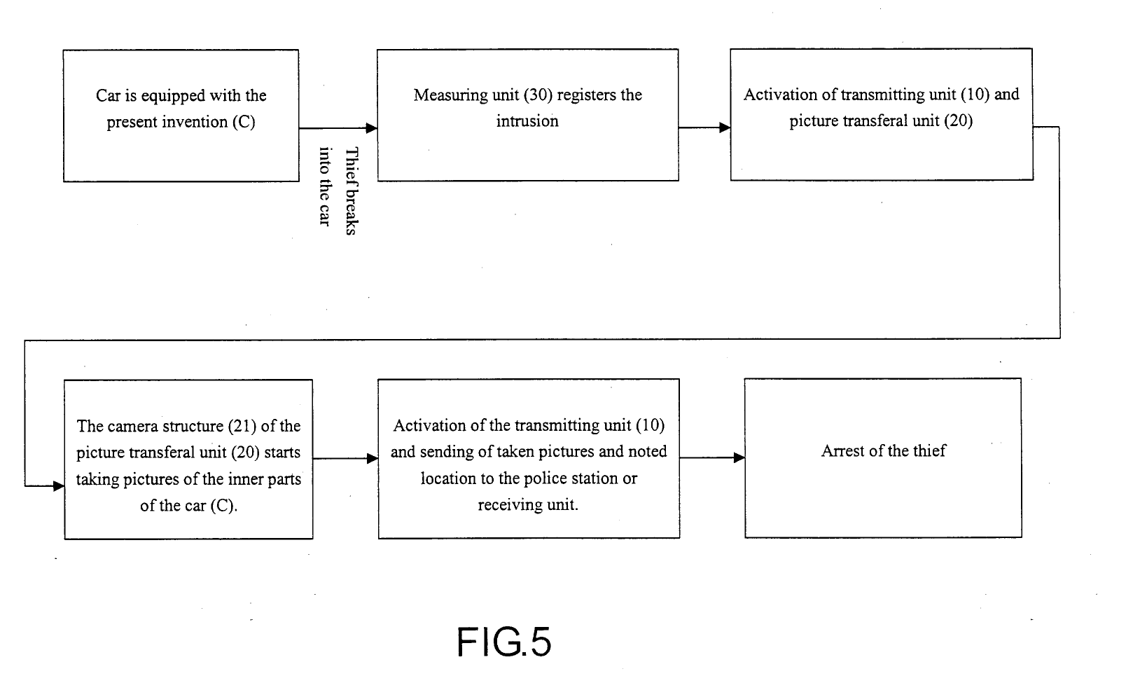

On FIG. 4 and FIG. 5 we can see that in case of an abnormal entering of a thief into the parked car (C) the measuring unit (30) of the warning system will register the abnormal entering of the thief into the car and automatically activate the transmitting unit (10) and the picture transferal unit (20). The camera structures (21) of the picture transferal unit (20) take immediate pictures of the inner and outer situation of the car (C). In case of a car theft, the transmitting unit (10) transfers immediate pictures of the location of the car (C) to the next police station or to the receiving unit (D) of the car owner. At the same time a picture of the car thief and the location of the car (C) are transmitted, helping to find and get back the car (C). Through the transmitting of the picture of the thief, the seizure of this thief will be easier.

Hereby the patent is applied for the present invention of an automatic warning system for cars, which provides in case of abnormal entering into the car as by a car thief or in case of a car accident the possibility to take immediate pictures of the situation and transfer them to the next police station or to a receiving unit, thus enabling them to take immediate appropriate measures. The above described example and the attached pictures refer to an example only, included in the patent, but not restricting the patent to the given features. Minor changes in structure, assembly or other details shall be included into this patent.

1. An automatic warning system for cars, comprising at least:
a transmitting unit installed in the car, which can send digital data via wireless transmission and which upon activation connects to a predefined receiving unit;
a picture transferal unit, which comprises at least one camera structure that is connected to the transmitting unit and which can send pictures taken inside and outside of the car to this transmitting unit;
a measuring unit, which is connected to the transmitting unit and the picture transferal unit and which registers collisions and abnormal entering into the car and automatically activates the transmitting unit and picture transferal unit;
wherein in case of abnormal entering into the car as by a car thief or in case of a car accident pictures of the inner and outer situation of the car are taken automatically and transferred to the predefined receiving unit, which can be placed at the next police station or with the car owner, thus enabling them to take immediate appropriate measures.

2. An automatic warning system for cars as recited in claim 1, wherein the complete warning system can be connected to a global positioning system (GPS), which determines the position of the car via satellite, as long as the warning system is activated.
